(19) United States
(12) Patent Application Publication
(10) Pub. No.: US 2026/0081531 A1
(43) Pub. Date: Mar. 19, 2026

(54) MULTI-PHASE CURRENT CONTROL BASED ON TEMPERATURE

(71) Applicant: Infineon Technologies Austria AG, Villach (AT)

(72) Inventors: Darryl TSCHIRHART, Newmarket (CA); Sutej R. CHALLA, Action, MA (US); Danny R. Clavette, Greene, RI (US)

(21) Appl. No.: 18/887,708

(22) Filed: Sep. 17, 2024

(51) Int. Cl. H02M 3/158; H02M 1/32

(52) U.S. Cl. CPC H02M 3/1584; H02M 1/327

(57) ABSTRACT

An apparatus includes a power converter controller associated with a first power converter PC1 receives a first temperature value (TPHASE1) indicating a temperature of a first power converter PC1. The first power converter PC1 supplies first current I1 to a load. The power converter controller associated with the first power converter PC1 receives a second temperature value (TPHASE2) indicating a temperature of a second power converter PC2. The second power converter supplies second current I2 to the load. The first power converter PC1 adjusts a magnitude of the first current I1 based on a comparison of the first temperature value TPHASE1 and the second temperature value TPHASE2.

### BACKGROUND

One type of conventional power converter is a buck converter. In general, to maintain an output voltage within a desired range, a controller associated with the buck converter compares the magnitude of a generated output voltage to a setpoint reference voltage. Based on a respective error voltage, the controller modifies a respective switching frequency and/or pulse width modulation associated with activating high side switch circuitry and low side switch circuitry in the buck converter to maintain a magnitude of the output voltage.

In certain instances, the controller controls operation of the buck converter and generation of the output voltage based on an amount of output current supplied by a generated output voltage to a load. For example, conventional techniques include receiving a so-called VID (Voltage Identification) from a load such as a processor being powered by the output voltage. The VID indicates a setpoint voltage in which to produce the output voltage to power the load. The magnitude of the VID setting (such as setpoint reference voltage) may vary depending on a magnitude of the output current. In a manner as previously discussed, the controller of the power supply can be configured to regulate a magnitude of the output voltage supplied to the load based on a target setpoint voltage derived from the received VID value.

Conventional power supply systems may include implementation of multiple buck converters in parallel to produce a respective output voltage that powers a load. Typically the power supply system includes a single controller operative to generate control signals for each of the multiple power converter phases. If there are many phases controlled by the single controller, many circuit paths are needed to support conveyance of control signals to each of the multiple power converter phases. Additionally, each of the power converter phases provides individual feedback to the single controller. Thus, additional circuit paths are needed to convey the feedback from the multiple power converter phases to the single controller.

### BRIEF DESCRIPTION

Implementation of clean energy (or green technology) is very important to reduce our impact as humans on the environment. In general, clean energy includes any evolving methods and materials to reduce an overall toxicity to the environment as caused by energy consumption.

This disclosure includes the observation that raw energy, such as received from green energy sources or non-green energy sources, typically needs to be converted into an appropriate form (such as desired AC voltage, DC voltage, etc.) before it can be used to power end devices such as servers, computers, mobile communication devices, etc. Regardless of whether energy is received from green energy sources or non-green energy sources, it is desirable to make most efficient use of raw energy provided by such systems to reduce our impact on the environment. This disclosure contributes to reducing our carbon footprint (and green energy) via more efficient energy conversion.

Additionally, this disclosure includes the observation that it is desirable to reduce the number of circuit paths needed to support conveyance signals between a controller and multiple power converter phases controlled by the controller. Reducing a number of circuit paths beneficially reduces the complexly of implementing a respective power supply including corresponding multiple power converter phases.

More specifically, an apparatus as discussed herein comprises: a first power converter operative to: receive a first temperature value indicating a temperature of the first power converter, the first power converter supplying first current to a load; receive a second temperature value indicating a temperature of a second power converter, the second power converter supplying second current to the load; and adjust a magnitude of the first current based on a comparison of the first temperature value and the second temperature value.

The comparison of the first temperature value and the second temperature value may indicate that the first power converter is lower in temperature than the second power converter. The first power converter can be configured to: receive a first pulse width modulation control signal, the first pulse width modulation control signal supplied to both the first power converter and the second power converter to control the first current and the second current; and in response to the first temperature value being less than the second temperature value, adjust timing of an edge of the received first pulse width modulation control signal to produce a second pulse width modulation control signal, the second pulse width modulation control signal operative to control a magnitude of the first current.

In one example, the edge is a trailing edge of the received first pulse width modulation control signal.

In another example, a duty cycle of the first pulse width modulation signal received by the first power converter is adjusted by a controller in response to the first power converter adjusting a magnitude of the first current.

Yet further, the first power converter can be configured to discontinue increasing the magnitude of the first current in response to detecting that the first temperature value is within a threshold level of the second temperature value.

Still further, the first power converter can be configured to adjust a magnitude of the first current via selection of a delay signal from a tapped delay line to control a respective timing of an edge of a first control signal controlling the magnitude of the first current.

As further discussed herein, the first power converter may be operative to adjust the magnitude of the first current via implementation of a first current starved inverter circuit, the current starved inverter circuit operative to adjust timing of a trailing edge of a first control signal to produce a second control signal, the second control signal operative to control the magnitude of the first current.

In accordance with another example, the first power converter can be configured to: i) receive a first control signal to control a magnitude of the first current, and ii) via a continuous delay element circuit, convert the first control signal into a second control signal, the current continuous delay element circuit operative to control timing of a trailing edge of the second control signal.

Another apparatus as discussed herein can be configured to include a first power converter operative to: receive a control signal supplied to each of multiple power converters including the first power converter and a second power converter; receive temperature information associated with the first power converter and the second power converter; and adjust the control signal based on the received temperature information, the adjusted control signal operative to control first current outputted from the first power converter to a load.

The temperature information may include a first temperature value and a second temperature value, where the first temperature value indicates a temperature of the first power converter and where the second temperature value indicates a temperature of the second power converter.

In one example, the control signal is a pulse width modulation control signal supplied to both the first power converter and the second power converter. Adjustment of the control signal based on the temperature information may include the first power converter or other suitable entity adjusting a duty cycle of the pulse width modulation control signal implemented by the first power converter to produce the first current in response to a condition in which the second temperature value is greater than the first temperature value. The adjusted duty cycle of the pulse width modulation control signal may be implemented by the first power converter is operative to reduce: i) a magnitude of second current supplied by the second power converter to the load, and ii) a magnitude of the temperature of the second power converter.

Additional examples as discussed herein include methods. One method includes operations of: receiving a first temperature value indicating a temperature of a first power converter, the first power converter supplying first current to a load; receiving a second temperature value indicating a temperature of a second power converter, the second power converter supplying second current to the load; and adjusting a magnitude of the first current based on a comparison of the first temperature value and the second temperature value.

Techniques as discussed herein are useful over conventional techniques. For example, the temperature-based adjustments to a common pulse width modulation control signal as discussed herein is a novel distributed control function supporting better balance of temperature. This, in turn, supports efficient power conversion via less complex power converter circuitry.

These and other more specific examples are disclosed in more detail below.

Note that although examples as discussed herein are applicable to power converters, the concepts disclosed herein may be advantageously applied to any other suitable topologies as well as general power supply control applications.

Note that any of the resources as discussed herein can include one or more computerized devices, controller, mobile communication devices, servers, base stations, wireless communication equipment, communication management systems, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to methods, systems, computer program products, etc., that support operations as discussed herein.

One example herein includes a computer readable storage medium and/or system having instructions stored thereon. The instructions, when executed by computer processor hardware, cause the computer processor hardware (such as one or more co-located or disparately located processor devices) to: receive a first temperature value (TPHASE1) indicating a temperature of a first power converter PC1, the first power converter PC1 supplying first current I1 to a load; receive a second temperature value (TPHASE2) indicating a temperature of a second power converter PC2, the second power converter supplying second current I2 to the load; and adjust a magnitude of the first current I1 based on a comparison of the first temperature value TPHASE1 and the second temperature value TPHASE2.

The ordering of the steps above has been added for clarity sake. Note that any of the processing operations as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be implemented strictly as a software program, firmware, as a hybrid of software, hardware and/or firmware, or as hardware alone such as within a processor (hardware or software), or within an operating system or a within a software application.

As discussed herein, techniques herein are well suited for use in the field of implementing one or more power converters to deliver current to a load. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be implemented and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating implementation of a power converter including multiple power converter phases controlled by a multiphase controller as discussed herein.

FIG. 2 is an example diagram illustrating a power converter and corresponding circuitry as discussed herein.

FIG. 3 is an example diagram illustrating implementation of the power converter including multiple power converter phases controlled by a multiphase controller as discussed herein.

FIG. 4 is an example diagram illustrating a power converter and corresponding circuitry as discussed herein.

FIG. 5 is an example timing diagram illustrating adjustment of a trailing edge of a pulse width modulation control signal to produce an outputted control signal as discussed herein.

FIG. 6 is an example diagram illustrating a pulse width modulation signal generator operable to adjust leading and/or trailing edges of a respective received control signal as discussed herein.

FIG. 7 is an example diagram illustrating a pulse width modulation signal generator operable to adjust leading and/or trailing edges of a respective received control signal as discussed herein.

FIG. 8 is an example diagram illustrating a variable delay circuit operative to delay a clock signal as discussed herein.

FIG. 9 is an example diagram illustrating delay versus input voltage associated with the variable delay circuit as discussed herein.

FIG. 10 is an example diagram illustrating a hybrid pulse width modulation signal generator providing edge delay as discussed herein.

FIG. 11 is an example flow chart diagram illustrating operations of controlling output of current from each of multiple different power converters as discussed herein.

FIG. 12 is an example diagram illustrating computer processor hardware and related software instructions operative to execute methods as discussed herein.

FIG. 13 is an example diagram illustrating a method and corresponding functionality associated with a circuit as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A power supply includes multiple power converter phases. As discussed herein, a power converter controller associated with a first power converter receives a first temperature value indicating a temperature of the first power converter. The first power converter supplies first current to a load. The power converter controller associated with the first power converter also receives a second temperature value indicating a temperature of a second power converter. The second power converter supplies second current to the load. The first power converter adjusts a magnitude of the first current based on a comparison of the first temperature value and the second temperature value.

Adjustment of the magnitude of the first current supplied by the first power converter to the load may include increasing a magnitude of the first current, which results in a decrease of the second current supplied by the second power converter to the load. The increase in the magnitude of the first current may increase the temperature of the first power converter while the decrease in the magnitude of the second current may decrease the temperature of the second power converter, resulting in a better balance of temperature between the first power converter and the second power converter even though they supply different magnitudes of current to the load.

As discussed herein, temperature sensing may be performed on a per loop basis, where each of multiple power converter TMON pins are tied together and fed to a TSEN pin of a central controller. In one example, the TMON signal communicated to the central controller may be an ORing of the highest voltage (corresponding to a highest temperature power converter). The highest voltage is encoded to indicate the temperature of the highest temperature power converter. In such an instance, the central controller of each power converter phases is aware of the highest temperature power converter amongst the multiple power converters collectively producing an output voltage and corresponding output current to power a load.

It is further noted that the temperature magnitude of each of the different power converters may vary depending upon a respective amount of current supplied to the load. As previously discussed, one function of the power converters and corresponding distributed controllers as discussed herein is to achieve better thermal balance amongst the multiple power converters, without an excessive current imbalance amongst the multiple power converters. In other words, monitoring of temperatures associated with the power converter phases and the thermal balance of the multiple power converters as discussed herein may result in current imbalance. However, the amount of thermal balancing amongst the power converter phases as discussed herein may be limited so that there is not excessive current imbalance amongst the different power converters providing respective current to the load.

As a more specific example as discussed herein, to achieve thermal balance, cooler phases (phases with temperature lower than the TMON signal of the hottest power converter) increase their respective duty cycle (such as by increasing edge delay of a received pulse width modulation control signal) to increase current provided by that power converter phase to the load. The increase in the current provided by the one or more cooler power converters reduces the amount of current provided by the hottest power converter. Reduction in the current provided by the hottest power converter results in cooling of the hottest power converter.

Note further that the power converter phases determined as being cooler than the hottest power converter phase may adjust any edge such as a trailing edge of a respective received pulse width modulation to increase the duty cycle of the received common pulse width modulation signal and provide a higher amount of current to the respective load. If desired, the leading edge of the received pulse width modulation control signal may be adjusted to achieve fine resolution.

As previously discussed, the increases in the current supplied by the cooler power converter phases results in reduction in the amount of current supplied by the hottest power converter phase. Thus, via a voltage regulation control loop implemented via a central controller as discussed herein, hotter phases will end up supplying less current to a load based on the cooler power converter phases increasing their current. The lowering of current supplied by the hottest power converter phase results in a lowering of the temperature of the hottest power converter phase such that the magnitude of temperatures associated with all of the power converter phases are more balanced with respect to each other within a certain limit.

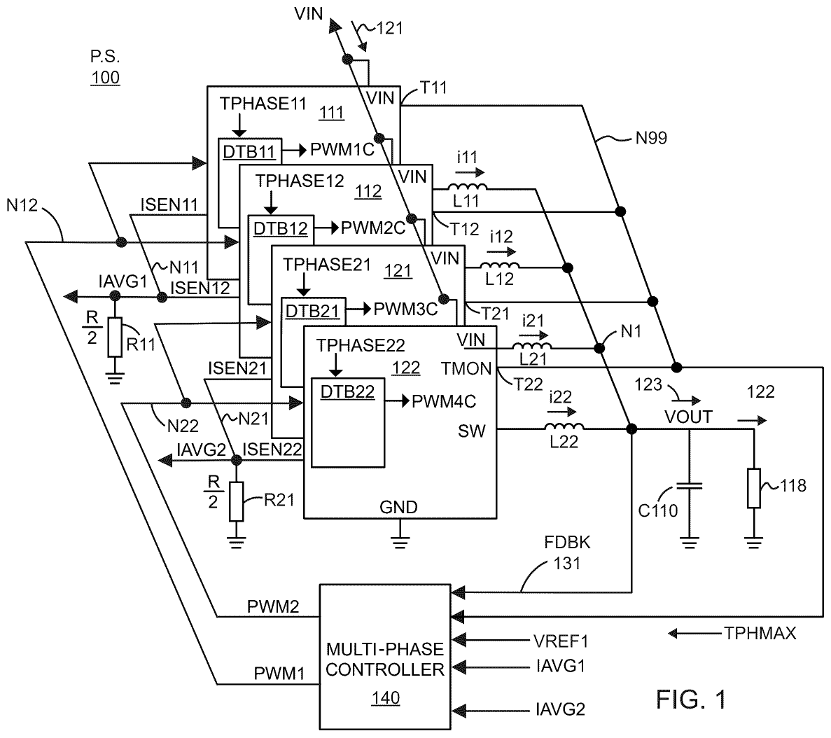

FIG. 1 is an example diagram illustrating implementation of a respective power supply including multiple distributed power converter phases controlled by a (central) multiphase controller as discussed herein.

As shown, power supply 100 in FIG. 1 includes controller 140 (such as a multiphase controller, current controller, controller hardware, etc.), resistor R11, resistor R21, power converter phase 111, power converter phase 112, power converter phase 121, power converter phase 122, output capacitor C110, and dynamic load 118.

Each of the power converters (such as power converter phases) as discussed herein can be configured to include a respective distributed temperature balancer function DTBxx (a.k. a., distributed temperature balancer, controller, hardware, circuitry, etc., such as being digital-circuit-based, analog-circuit-based, or a combination of analog-circuit-based and digital-circuit-based). Via the distributed temperature balance functions DTBxx, the hotter power converter phases will end up supplying less current (reducing their temperature) based on the cooler power converter phases increasing their output current supplied to the dynamic load 118.

For example, the power converter phase 111 includes temperature balance function DTB11 (such as a Distributed Temperature Balancer DTB11), the power converter phase 112 includes temperature balance function DTB12 (such as a Distributed Temperature Balancer DTB12), the power converter phase 121 includes temperature balance function DTB21 (such as a Distributed Temperature Balancer DTB21), the power converter phase 122 includes the temperature balance function DTB22 (such as a Distributed Temperature Balancer DTB22).

The power converter phases are operated in parallel to produce the output voltage 123 and corresponding output current 122 supplied to the dynamic load 118.

Accordingly, each temperature balance function as discussed herein can be considered a controller, signal generator, etc.

Each of the power converter phases in the power supply 100 can be configured to produce a respective feedback signal indicating a magnitude of corresponding current supplied by that power converter phase to the load 118.

For example, the power converter phase 111 includes a corresponding current monitor operative to measure a magnitude of the current i11 supplied by the power converter phase 111 through the inductor L11 to the corresponding load 118. The current i11 contributes to generation of output current 122 and maintaining a magnitude of the output voltage 123 at a desired setpoint reference voltage VREF1. The temperature balance function DTB11 or other suitable entity associated with the power converter phase 111 produces the respective output signal ISEN11 indicating a magnitude of the current i11. In one example, the signal ISEN11 is a current proportional to the magnitude of the current i11. The signal ISEN11 is outputted from the power converter phase 111 to the node N11 (circuit path), where the corresponding current from the signal ISEN11 flows through the resistor R11 to the ground reference voltage.

The power converter phase 112 includes a corresponding current monitor operative to measure a magnitude of the current i12 supplied by the power converter phase 112 through the inductor L12 to the corresponding load 118. The current i12 contributes to maintaining a magnitude of the output voltage 123 at a desired setpoint reference voltage VREF1. The temperature balance function DTB12 or other suitable entity associated with the power converter phase 112 produces the respective signal ISEN12 indicating a magnitude of the current i12. In one example, the signal ISEN12 is an outputted current proportional to the magnitude of the current i12. The signal ISEN12 is outputted from the power converter phase 112 to the node N11, where the corresponding current from the signal ISEN12 flows through the resistor R11 to the ground reference voltage.

In such an instance, the voltage IAVG1 at node N11 supplied to the multiphase controller 140 indicates a magnitude of total current (such as magnitude of total current as being summation of current i11 and current i12) provided by a combination of the power converter phase 111 and power converter phase 112 to the load 118. Accordingly, communication of the signal IAVG1 to the controller 140 indicates a total current provided by a combination of the power converter phase 111 and the power converter phase 112 to the load 118.

As further shown, the power converter phase 121 includes a corresponding current monitor operative to measure a magnitude of the current i21 supplied by the power converter phase 121 through the inductor L21 to the corresponding load 118. The current i21 contributes to generation of the output current 122 and maintaining a magnitude of the output voltage 123 at a desired setpoint reference voltage VREF1. The temperature balance function DTB21 or other suitable entity associated with the power converter phase 121 produces the respective signal ISEN21 indicating a magnitude of the current i21. In one example, the signal ISEN21 is a current proportional to the magnitude of the current i21. The signal ISEN21 is outputted from the power converter phase 121 to the node N21 (such as circuit path), where the corresponding current from the signal ISEN21 flows through the resistor R21 to the ground reference voltage.

The power converter phase 122 includes a corresponding current monitor operative to measure a magnitude of the current i22 supplied by the power converter phase 112 through the inductor L22 to the corresponding load 118. The current i22 contributes to maintaining a magnitude of the output voltage 123 at a desired setpoint reference voltage VREF1. The temperature balance function DTB22 or other suitable entity associated with the power converter phase 122 produces the respective signal ISEN22 indicating a magnitude of the current i22. In one example, the signal ISEN22 is a current proportional to the magnitude of the current i22. The signal ISEN22 is outputted from the power converter phase 122 to the node N21, where the corresponding current from the signal ISEN22 flows through the resistor R21 to the ground reference voltage.

In such an instance, the voltage IAVG2 at node N12 indicates a magnitude of total current (such as magnitude of total current as being summation of current i21 and current i22) provided by the power converter phase 121 and power converter phase 122 to the load 118. Accordingly, communication of the signal IAVG2 to the controller 140 indicates a total current provided by a combination of the power converter phase 121 and the power converter phase 122 to the load 118.

It is further noted that each of the power converter phases as discussed herein includes a respective terminal to receive or transmit temperature information. For example, the power converter phase 111 includes the terminal T11 (such as node, pin, port, etc.); the power converter phase 112 includes the terminal T12 (such as node, pin, port, etc.); the power converter phase 121 includes the terminal T21 (such as node, pin, port, etc.); the power converter phase 122 includes the terminal T22 (such as node, pin, port, etc.).

Each of the terminals T11, T12, T21, T22 are connected to a common node N99, which supplies signal TPHMAX to the multiphase controller 140. The power converter being of the highest temperature outputs the signal TPHMAX to the other power converters. In one example, each of the power converter phases attempts to output a respective signal to the node N99, where the output signal is encoded to indicate a temperature of the respective power converter phase transmitting the signal. However, the combination of the outputted temperature signals operates in an ORing fashion such that the signal TPHMAX represents the temperature signal transmitted by the hottest power converter phase. Thus, the multiphase controller 140 may not know which one is the hottest power converter phase, but is notified of the hottest power converter phase. Via the signal TPHMAX, each of the power converter phases is also aware of the hottest power converter phase, which may or may not be itself. Each power converter phase also is aware of its own temperature.

As further shown in FIG. 1, the multiphase controller 140 can be configured to receive feedback signal 131 indicating a magnitude of the output voltage 123. Note further that the controller 140 also receives the setpoint reference voltage VREF1, indicating a desired magnitude in which to control the magnitude of the output voltage 123.

Based on the received feedback 131 (magnitude of the output voltage 123) and corresponding reference voltage VREF1, the controller 140: i) generates the pulse width modulation control signal PWM1 to control a magnitude of respective output current supplied by each of the power converter phase 111 and power converter phase 112 to the load 118, and ii) generates the pulse width modulation control signal PWM2 to control a magnitude of the respective output current supplied by each of the power converter phase 121 and power converter phase 122 to the load 118.

As further discussed herein, each of the power converter phases provides adjustment to the respective pulse width modulation signal received from the multiphase controller 140 such that the power converter phases themselves also provide temperature regulation of the power converter phases.

More specifically, in furtherance of controlling (regulating) the magnitude of the output voltage 123, the controller 140 produces the respective pulse width modulation control signals PWM1 and PWM2. Each of the respective groups of power converter phases receives a respective pulse width modulation control signal indicating the target magnitude of controlling a respective output current to the load. Rather than simply use the received pulse width modulation control signal received from the controller 140 to drive the corresponding high-side and low-side switches in the respective power converter phase, each of the power converter phases further implements a respective temperature balance function that supports equalizing or providing better balance of the magnitude of the power converter temperatures by that group (such as a first group including the power converter phase 111, power converter phase 112, etc., or a second group including the power converter phase 121, power converter phase 122, etc.) to the load 118.

More specifically, the controller 140 produces the respective pulse width modulation control signal PWM1 and supplies it over node N12 (i.e., circuit path) to the power converter phase 111 and the power converter phase 112.

The controller 140 produces the respective pulse width modulation control signal PWM2 and supplies it over node N22 (i.e., circuit path) to the power converter phase 121 and the power converter phase 122.

As discussed herein, in general, the respective temperature balance function associated with each of the power converters 111 and 112 adjusts the received pulse width modulation control signal PWM1 to control its respective output current such that each of the power converter phases 111 and 112 adjusts its respective current (for example, i11 and i12) to the load 118 such that the temperature of the power converter phases are closer in magnitude to each other. Thus, the function of providing temperature balance amongst the multiple power converter phases as discussed herein is distributed to the power converter phases themselves as opposed to the controller 140 having the burden of producing and transmitting individual control signals to each of the power converter phases to balance power converter phase temperature.

As further shown, the controller 140 produces the respective pulse width modulation control signal PWM2 and supplies it over node N22 (i.e., circuit path) to the power converter phase 121 and the power converter phase 122. As discussed herein, the respective temperature balance function associated with each of the power converters adjusts the received pulse width modulation control signal PWM2 such that each of the power converter phases 121 and 122 adjusts its respective output current (for example, i21 and i22) to the load 118 such that the temperature of the power converter phases are closer in magnitude to each other, providing better temperature balance amongst the power converter phases. Thus, the function of providing temperature balance amongst the multiple power converter phases is distributed to the power converter phases themselves as opposed to the controller 140 having the burden of producing and transmitting individual control signals to each of the power converter phases to balance power converter phase temperature.

It is further noted that the controller 140 can be configured to control the groupings of power converter phases to provide different magnitudes of current to the respective load 118. For example, the controller 140 can be configured to generate the control signal PWM1 to supply a first magnitude of current (sum of current i11 and i12 such as 20 amps or other suitable amount) from a combination of the power converter phase 111 and the power converter phase 112 to the load. The controller 140 can be configured to generate the control signal PWM2 to supply a second magnitude of current (sum of current i21 and i22 such as 40 amps or other suitable amount) from a combination of the power converter phase 121 and the power converter phase 122 to the load 118.

The additional function of providing temperature balance amongst the power converter phases as discussed herein reduces stress associated with the power converter phases that supply respective current to the load. For example, if the total current required by a load is 40 amps and each of the first power converter phase and the second power converter phase is controlled to supply 20 amperes to the load without adjustments by the individual power converter phases, this may stress the first power converter phase (such as being a temperature of 100 degrees Celsius) and not stress the second power converter phase (such as being a temperature of 70 degrees Celsius). Based on the temperature balancing as discussed herein, the second power converter phase may increase its magnitude of supplying current to the load from 20 amps to 25 amps. This increase in output current hide by the second power converter phase may result in the second power converter phase increasing in temperature, however, this reduces the amount of current required to be delivered by the first power converter to the load, which reduces a temperature of the first power converter. Distributed balancing of each of the power converters to a temperature around 85 degrees based on each implementing output current adjustments may result in the first power converter supplying 15 amperes while the second power converter supplies 25 amperes to the load, resulting in both of the first power converter phase of the second power converter phase being nearer in temperature to each other such as 85 degrees Celsius each.

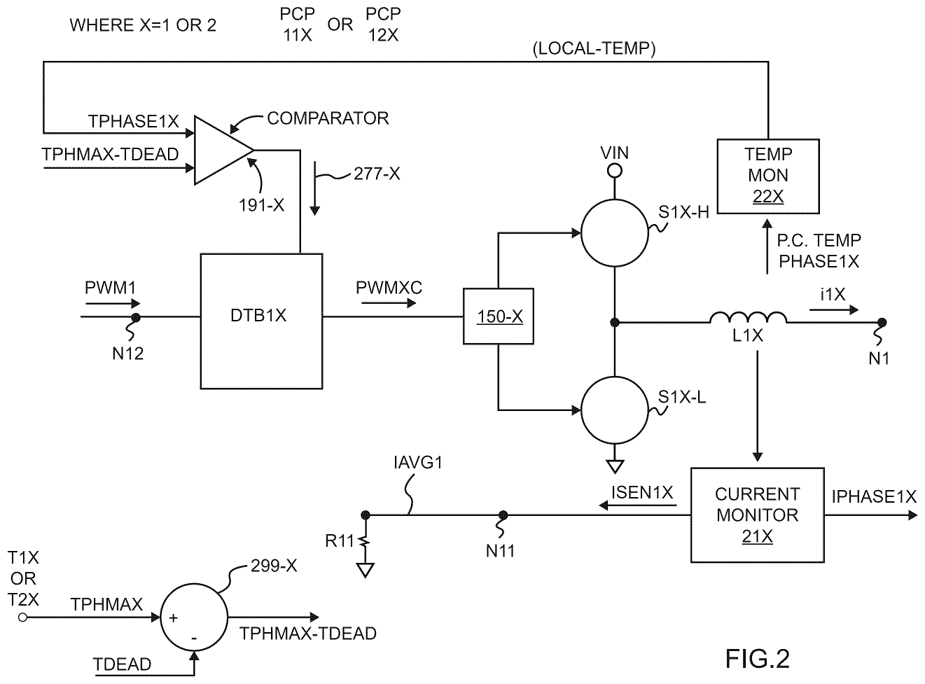

FIG. 2 is an example diagram illustrating a power converter and corresponding circuitry as discussed herein.

This example illustrates the circuitry associated with each of the power converter phases as shown in FIG. 1. As discussed below, the value of X may be 1 or 2, corresponding to the different power converter phases, each of which operate in a similar manner.

For example, each of the respective power converter phases (power converter phase 111, 112, etc.) includes a temperature balance function DTB1X, driver circuitry 150-X, high-side switch circuitry S1X-H, low side switch circuitry S1X-L, inductor L1X, temperature monitor 22X, and current monitor 21X.

In such an instance, the power converter phase 111 (11) includes a temperature balance function DTB11, driver circuitry 150-1, high-side switch circuitry S11-H, low side switch circuitry S11-L, inductor L11, temperature monitor 221, and current monitor 211; the power converter phase 112 (12) includes a temperature balance function DTB12, driver circuitry 150-2, high-side switch circuitry S12-H, low side switch circuitry S12-L, inductor L12, temperature monitor 222, and current monitor 212, and so on.

As previously discussed, the temperature balance function DTB1X receives the pulse width modulation control signal PWM1 generated by the controller 140. The temperature balance function DTB1X also receives the local temperature TPHASE1X (temperature of itself) of the power converter phase 1X and the temperature value (TPHMAX) indicating a highest temperature of a remote power converter phase producing the respective output voltage 123. If the respective power converter phase 1X is the highest temperature, then the temperature TPHASE1X equals TPHMAX and the corresponding power converter phase outputs this value to the other power converter phases.

As discussed herein, if the given power converter phase is the highest temperature amongst all the phases, then that power converter phase does not adjust the duty cycle of the received pulse width modulation signal PWM1 to produce the pulse width modulation control signal PWMXC. However, if the given power converter phase is not the highest temperature amongst all the phases as determined from the local temperature value with respect to the received highest temperature TPHMAX from the hottest power converter phase through the terminal T1X, then that power converter phase can be configured to adjust the duty cycle of the received pulse width modulation signal PWM1 to produce the pulse width modulation control signal PWMXC. In this latter instance, because the power converter phase is not the highest temperature, the temperature balance function DTB1X increases the duty cycle of the received pulse width modulation signal PWM1 to control switch circuitry S1X-H to produce the pulse width modulation control signal PWMXC. The increased duty cycle increases a magnitude of the amount of current i1X supplied by that power converter phase to the load 118.

As further shown, the respective power converter phase can be configured to include summer function 299-X to receive the signal TPHMAX and signal TDEAD. Signal TDEAD is a temperature margin value. The summer function 299-X produces the signal TPHMAX minus TDEAD (TPHMAX-TDEAD) and supplies it to the comparator function 191-X. In one example, the comparator function 191-X compares the signal (TPHMAX-TDEAD) to the local temperature TPHASE1X of the power converter phase 1X. If the local temperature TPHASE1X of the power converter phase 1X as indicated by signal 277-X is less than the signal (TPHMAX-TDEAD), the temperature balance function DTB1X adjusts (increases) the duty cycle of the received pulse width modulation signal PWM1 to produce the pulse width modulation control signal PWMXC used to control the respective switches S1X-H and S1X-L. The increased duty cycle associated with the pulse width modulation signal PWMXC increases a magnitude of the current i1X supplied by that power converter phase to the corresponding load 118.

Thus, if the first power converter phase determines that it is not the hottest power converter phase, it can be configured to increase the magnitude of its output current supplied to the load 118, resulting in an increase in a temperature of the first power converter phase. The increase in magnitude of the output current supplied by the first power converter phase to the load 118 results in a reduced temperature of the second power converter phase.

As discussed herein, the duty cycle or pulse width ON-time associated with the adjusted pulse width modulation control signal PWMXC can be increased or decreased by adjusting one or more of a leading edge or trailing edge of the corresponding control signal PWMXC. Thus, the leading edge or trailing edge of the control signal PWM1 and/or control signal PWMXC can be adjusted such that the lower temperature power converter phases supply more current to the dynamic load 118.

Accordingly, with reference to FIG. 1, the temperature balance function DTB11 can be configured to receive a first temperature value (local temperature TPHASE1 of the power converter 111) indicating a temperature of the first power converter 111, the first power converter 111 supplying first current i11 to the dynamic load 118. The power converter 112 may operate at a second temperature (hottest temperature) resulting in transmission of a second temperature value (TPHASE2 or TPHMAX) to the power converter phase 111 via node N99. The second temperature value TPHASE2 or TPHMAX received from the power converter phase 112 indicates the temperature of the second power converter 112. The second power converter phase 112 supplies second current i12 to the load 118. The power converter phase 111 and corresponding temperature balance function DTB11 can be configured to compare the first temperature value TPHASE1 or TPHMAX or adjusted value (TPHMAX-TDEAD) to the second temperature value TPHASE2 to learn that the power converter phase 111 is at a substantially lower temperature than the power converter phase 112. In such an instance, the power converter phase 111 adjusts the duty cycle associated with the received pulse width modulation control signal PWM1 to produce the adjusted pulse width modulated control signal PWM1C controlling the magnitude of the current i11 supplied by the power converter phase 111 to the load 118. In one example, adjustment of the magnitude of the first current i11 based on a comparison of the first temperature value TPHASE1 and the second temperature value TPHASE2 or TPHMAX or (TPHMAX-TDEAD) includes power converter phase 111 increasing the duty cycle associated with the pulse width modulation control signal PWM1C (relative to the received pulse width modulation control signal PWM1) such that the power converter 111 supplies an increase amount of current i11 to the load 118. The increased magnitude of current supplied to the load 118 may result in the magnitude of the output voltage 123 temporarily increasing. Via a first feedback loop, the multiphase controller 140 receives the feedback 131 such as the magnitude of the output voltage 123 and then adjusts the duty cycle of the pulse width modulation control signal PWM1 such that the magnitude of the voltage is regulated with respect to a desired setpoint reference voltage VREF1. The second control loop implemented by the power converter phases uses temperature as a basis in which to locally and individually (in a distributed manner at each of the different power converter phases) adjust output current from each phase such that the temperature associated with each of the different power converters is more balanced (more similar magnitude, although not necessarily exactly equal but at least within a temperature margin value such as TDEAD).

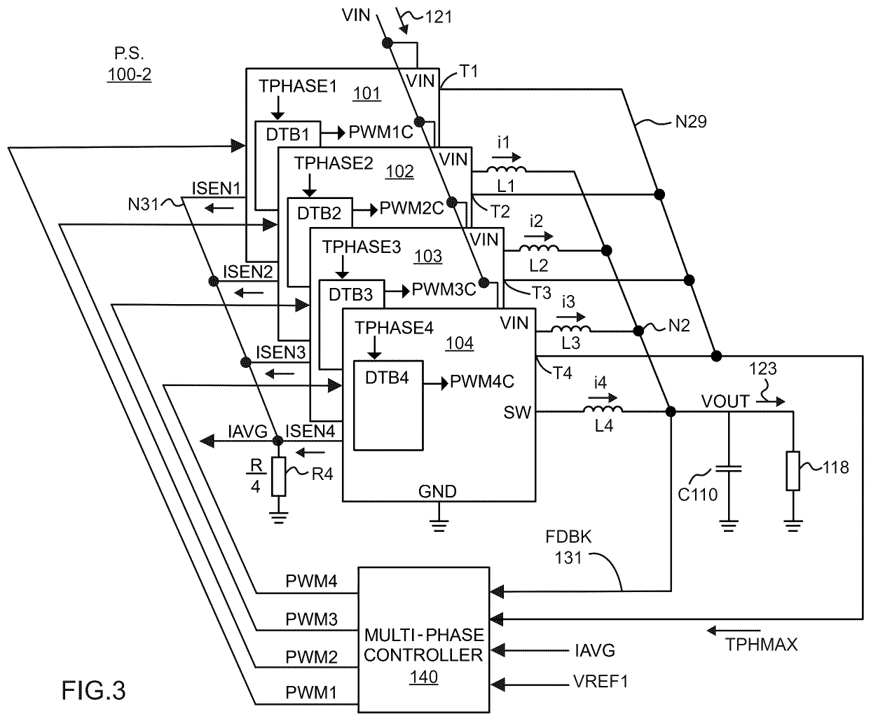

FIG. 3 is an example diagram illustrating implementation of the power converter including multiple power converter phases controlled by a multiphase controller as discussed herein.

As shown, power supply 100-2 in FIG. 3 includes controller 140 (such as a multiphase controller, current controller, controller hardware, etc.), resistor R4, power converter phase 101, power converter phase 102, power converter phase 103, power converter phase 104, output capacitor C110, and dynamic load 118.

Each of the power converters as discussed herein can be configured to include a respective temperature balancer function (a.k. a., temperature balancer, controller, hardware, circuitry, etc., such as being digital-circuit-based, analog-circuit-based, or a combination of analog-circuit-based and digital-circuit-based). For example, the power converter phase 101 includes temperature balance function DTB1 (such as Distributed Temperature Balancer DTB1), the power converter phase 102 includes temperature balance function DTB2 (such as Distributed Temperature Balancer DTB2), the power converter phase 103 includes temperature balance function DTB3 (such as Distributed Temperature Balancer DTB3), the power converter phase 104 includes the temperature balance function DTB4 (such as Distributed Temperature Balancer DTB4).

Accordingly, each temperature balance function as discussed herein can be considered a controller, signal generator, etc.

Each of the power converter phases in the power supply 100-2 produces a respective feedback signal indicating a magnitude of corresponding current supplied by that power converter phase to the load 118.

For example, the power converter phase 101 includes a corresponding current monitor operative to measure a magnitude of the current i1 supplied by the power converter phase 101 through the inductor L1 to the corresponding load 118. The current i1 contributes to maintaining a magnitude of the output voltage 123 at a desired setpoint reference voltage VREF1. The power converter phase 101 or other suitable entity produces the respective signal ISEN1 indicating a magnitude of the current i1. In one example, the signal ISEN1 is a current proportional to the magnitude of the current i1. The signal ISEN1 is outputted from the power converter phase 101 to the node N31 (circuit path), where the corresponding current from the signal ISEN1 flows through the resistor R4 to the ground reference voltage.

The power converter phase 102 includes a corresponding current monitor operative to measure a magnitude of the current i2 supplied by the power converter phase 102 through the inductor L2 to the corresponding load 118. The current i2 contributes to maintaining a magnitude of the output voltage 123 at a desired setpoint reference voltage VREF1. The power converter phase 102 produces the respective signal ISEN2 indicating a magnitude of the current i2. In one example, the signal ISEN2 is a current proportional to the magnitude of the current i2. The signal ISEN2 is outputted from the power converter phase 102 to the node N31, where the corresponding current from the signal ISEN2 flows through the resistor R4 to the ground reference voltage.

The power converter phase 103 includes a corresponding current monitor operative to measure a magnitude of the current i3 supplied by the power converter phase 103 through the inductor L3 to the corresponding load 118. The current i3 contributes to maintaining a magnitude of the output voltage 123 at a desired setpoint reference voltage VREF1. The power converter phase 103 produces the respective signal ISEN3 indicating a magnitude of the current i3. In one example, the signal ISEN3 is a current proportional to the magnitude of the current i3. The signal ISEN3 is outputted from the power converter phase 103 to the node N31, where the corresponding current from the signal ISEN3 flows through the resistor R4 to the ground reference voltage.

The power converter phase 104 includes a corresponding current monitor operative to measure a magnitude of the current i4 supplied by the power converter phase 104 through the inductor L4 to the corresponding load 118. The current i4 contributes to maintaining a magnitude of the output voltage 123 at a desired setpoint reference voltage VREF1. The power converter phase 104 produces the respective signal ISEN4 indicating a magnitude of the current i4. In one example, the signal ISEN4 is a current proportional to the magnitude of the current i4. The signal ISEN4 is outputted from the power converter phase 104 to the node N31, where the corresponding current from the signal ISEN4 flows through the resistor R4 to the ground reference voltage.

In such an instance, the voltage IAVG at node N31 indicates a magnitude of total current (such as magnitude of total current being summation of currents i1, i2, i3, and i4) provided by the power converter phases 101, 102, 103, and 104, to the load 118.

Accordingly, communication of the signal IAVG to the controller 140 indicates a total current provided by a combination of the power converter phases to the load 118.

As further shown in FIG. 3, the controller 140 can be configured to receive feedback signal 131 indicating a magnitude of the output voltage 123. Note further that the controller 140 also receives the setpoint reference voltage VREF1, indicating desired magnitude in which to control the magnitude of the output voltage 123.

The controller 140 generates the pulse width modulation control signals PWM1 to control a magnitude of respective output current i1 supplied by the power converter phase 101 to the load 123.

The controller 140 generates the pulse width modulation control signals PWM2 to control a magnitude of respective output current i2 supplied by the power converter phase 102 to the load 123.

The controller 140 generates the pulse width modulation control signals PWM3 to control a magnitude of respective output current i3 supplied by the power converter phase 103 to the load 123.

The controller 140 generates the pulse width modulation control signals PWM4 to control a magnitude of respective output current i4 supplied by the power converter phase 104 to the load 123.

In furtherance of controlling the magnitude of the output voltage 123, the controller 140 produces the respective pulse width modulation control signals PWM1, PWM2, PWM3, and PWM4.

Rather than simply use the received pulse width modulation control signal received from the controller 140, each of the power converter phases implements a respective temperature balance function that supports better equalizing of the magnitude of temperature associated with each of the power converter phases 101, 102, 103, and 104.

More specifically, the controller 140 produces the respective pulse width modulation control signal PWM1 and supplies it to the power converter 101. As discussed herein, the respective temperature balance function DTB1 of the power converter 101 adjusts the pulse width modulation control signal PWM1 to produce the pulse width modulation control signal PWM1C; the respective temperature balance function DTB2 of the power converter 102 adjusts the pulse width modulation control signal PWM2 to produce the pulse width modulation control signal PWM2C; the respective temperature balance function DTB3 of the power converter 103 adjusts the pulse width modulation control signal PWM3 to produce the pulse width modulation control signal PWM3C; the respective temperature balance function DTB4 of the power converter 104 adjusts the pulse width modulation control signal PWM4 to produce the pulse width modulation control signal PWM4C; and so on.

In a similar manner as previously discussed, the temperature balance function DTB1 can be configured to receive a first temperature value (local temperature TPHASE1 of the power converter 101) indicating a temperature of the first power converter 101, the first power converter 101 supplying first current i1 to the dynamic load 118. Assume that the power converter 102 operate at a second temperature (hottest temperature) resulting in transmission of a second temperature value (TPHASE2 or TPHMAX) to the power converter phase 101 via node N29. The second temperature value TPHASE2 or TPHMAX received from the power converter phase 102 indicates the temperature of the second power converter 112. The second power converter phase 112 supplies second current i2 to the load 118. The power converter phase 111 and corresponding temperature balance function DTB1 can be configured to compare the first temperature value TPHASE1 or TPHMAX or adjusted value (TPHMAX-TDEAD) to the second temperature value TPHASE2 to learn that the power converter phase 101 is a substantially lower temperature than the power converter phase 102. In such an instance, the power converter phase 101 adjusts the duty cycle associated with the received pulse width modulation control signal PWM1 to produce the adjusted pulse width modulated control signal PWM1C to increase the magnitude of the current i1 supplied by the power converter phase 101 to the load 118.

Thus, via a first feedback loop, the multiphase controller 140 receives the feedback 131 such as the magnitude of the output voltage 123 and then adjusts the duty cycle of the pulse width modulation control signals PWM1, PWM2, PWM3, etc., such that the magnitude of the voltage is regulated with respect to a desired setpoint reference voltage VREF1. The second control loop implemented by each of the power converter phases uses temperature as a basis in which to locally (in a distributed manner at each of the different power converter phases) further adjust output current from each phase that is greater than the max temperature phase adjusted by a threshold amount such that the temperature associated with each of the different power converters is more balanced (more similar in magnitude, although not necessarily exactly equal but at least within a temperature margin such as TDEAD).

Thus, the function of providing temperature balance amongst the multiple power converter phases is distributed to the power converter phases themselves as opposed to the controller 140 having the burden of producing and transmitting individual control signals to balance temperature associated with each of the power converter phases.

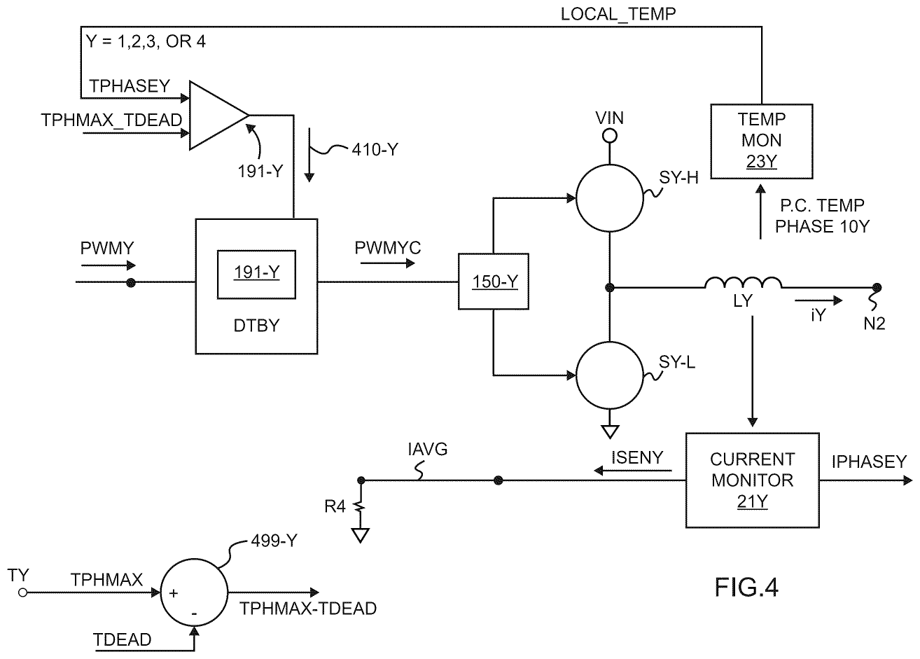

FIG. 4 is an example diagram illustrating a power converter and corresponding circuitry as discussed herein.

This example illustrates the circuitry associated with each of the power converter phases 10Y as shown in FIG. 4. As discussed below, the value of Y may be 1 (for power converter phase 101), 2 (for power converter phase 102), 3 (for power converter phase 103), or 4 (for power converter phase 104). If desired, this can be extended to include any number of PWM signals.

For example, each respective power converter phase 10Y includes a temperature balance function DTBY, driver circuitry 150-Y, high-side switch circuitry SY-H, low side switch circuitry SY-L, inductor LY, and current monitor 21Y.

As previously discussed, the temperature balance function DTBY receives the pulse width modulation control signal PWMY generated by the controller 140. The temperature balance function DTBY also receives a temperature signal TPHMAX indicating a maximum temperature of a remote power converter phase other than the power converter phase 10Y.

Comparator 191-Y produces the signal 410-Y indicating whether TPHASEY<[TPHMAX-TDEAD]. If the magnitude of the TPHASEY is less than [TPHMAX-TDEAD], the temperature balance function DTBY adjusts the duty cycle associated with the received pulse width modulation signal PWMY to increase a magnitude of the duty cycle time that the high-side switch circuitry SY-H is active during each cycle such that the magnitude of the current iY supplied to the load 118 increases.

If the local temperature TPHASEY of the current power converter phase 10Y is the maximum temperature of all the phases, then the power converter phase 10Y outputs the respective signal TPHASEY as signal TPHMAX from the terminal TY to the other power converter phases.

In one example, as previously discussed, the highest temperature power converter phase does not adjust the duty cycle associated with the received pulse width modulation signal PWMY to produce the pulse width modulation signal PWMYc. In other words, in this latter instance, the control signal PWMYC is a slightly delayed version of the received pulse width modulation signal PWMY with the same duty cycle.

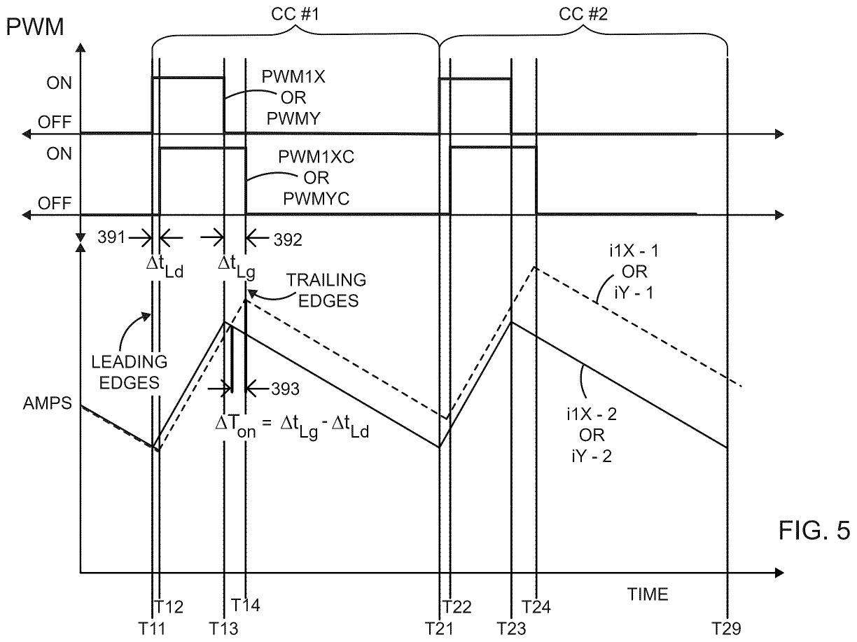

FIG. 5 is an example timing diagram illustrating adjustment of a trailing edge of a pulse width modulation control signal as discussed herein.

As previously discussed, examples herein may include modifying any edges (leading or trailing) of a respective pulse width modulation control signal (such as PWM1, PWM2, PWM3, PWM4, etc.) to provide temperature balance amongst multiple power converter phases as discussed herein.

In this example of implementing trailing edge timing adjustments, based on the power converter phases in FIG. 1, the temperature balance function DTB1X (where X equals 1 or 2) receives the control signal PWM1 as previously discussed and converts it into the respective control signal PWM1XC. In the case where the magnitude of the temperature of the corresponding power converter phase 11X is less than the temperature of the hottest power converter phase, the corresponding temperature balance function DTB1X delays the respective trailing edge of the received control signal PWMXC, resulting in an increased time in which the high-side switch circuitry S1X-H is activated in a respective control cycle. In other words, the delay of the trailing edge (from time T13 to time T14 or other suitable time such as is indicated by the trailing edge delay 392) associated with the control signal PWMXC resulting in a longer ON-time of the respective high-side switch circuitry S1X-H in a respective control cycle increases a magnitude of the respective output current i1X supplied to the load 118 as shown in FIG. 5 by output current i1X-1. The signal i1X-2 in FIG. 5 indicates a lower magnitude of the output current i1X using the original signal PWM1X (if otherwise used) without lengthening an ON-time duration of the high-side switch circuitry S1X-H via the delay of the trailing edge.

Thus the pulse width on time of the control signal PWM1X is between time T11 and time T13. The adjusted pulse width (longer pulse width) associated with the signal PWM1XC is between time T12 and time T14, which is longer in duration than the time between time T11 and time T13.

The temperature balance functions in FIG. 3 operate in a similar manner. More specifically, in this example of implementing trailing edge timing adjustments, the temperature balance function DTBY (where Y equals 1 to 4) receives the control signal PWMY and converts it into the control signal PWMYC in a manner as previously discussed. In the case where the magnitude of the temperature of the power converter phase 10Y is less than the temperature TPHMAX of the hottest power converter phase or the temperature of the power converter phase 10Y is less than the value TPHMAX-TDEAD, the corresponding temperature balance function DTB1Y delays the respective trailing edge of the control signal PWMYC, resulting in an increased time in which the high-side switch circuitry S1Y-H is activated in a respective control cycle. The delay of the trailing edge (from time T13 to time T14 or other suitable time) associated with the control signal PWMYC results in a longer ON-time of the respective high-side switch circuitry SY-H in a respective control cycle increases a magnitude of the respective output current iY supplied to the load 118 as shown in FIG. 5 by output current iY-1.

It is noted that adjustment of the trailing edge of the respective control signal such as via the delay delta TON as discussed herein changes the pulse width ON duration associated with the originally received pulse width modulation signal PWM1X or PWMY to produce the corresponding pulse width modulation control signal PWM1XC or PWMYC without a change in a corresponding switching frequency. In other words, the switching frequency of the trailing edge adjusted pulse width modulation control signal produced and outputted by the temperature balance function is the same as the pulse width modulation control signal received by the temperature balance function from the controller 140. As further shown in FIG. 5, the period associated with cycle #1 is equal to the period associated with cycle #2.

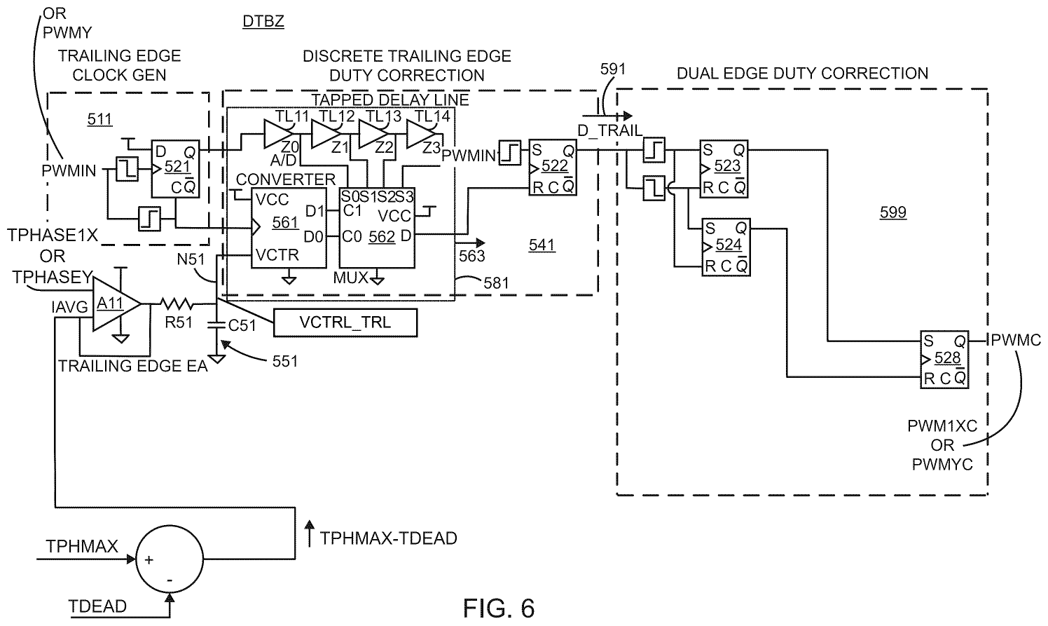

FIG. 6 is an example diagram illustrating a pulse width modulation signal generator operable to adjust leading and trailing edges of a respective received control signal as discussed herein.

In this example, the current balance function DTBz (such as any of the current balance functions DTB11, DTB12, DTB21, DTB22, DTB1, DTB2, DTB3, DTB4, etc., as previously discussed) includes a respective instance of the circuitry shown in FIG. 6 such as amplifier A11, integrator circuit 551, a trailing edge clock generator 511, circuitry 541 providing discrete trailing edge duty correction, and circuitry 599 providing edge duty control/correction.

As further shown, the integrator circuit 551 includes a resistor R51 and capacitor C51. The integrator circuit 552 includes a resistor R52 and a capacitor C52.

The trailing edge clock generator 511 includes the D flip-flop element 521. The leading edge clock generator 512 includes the D flip-flop element 531.

In this example, the signal PWMIN represents the corresponding signal PWM1, PWM2, PWM3, PWM4, PWM1X, PWMY, etc., as previously discussed. The trailing edge clock generator 511 includes the D flip-flop 521 that forwards the received PWMIN clock signal to the tapped delay line including series connected tapped delay line element TL11, tapped delay line element TL12, tapped delay line element TL13, tapped delay line element TL14. As their names suggest, each of the tapped delay line elements delays the respective input pulse width modulation PWMIN signal by a same or different amount of time.

The integrator circuit 551 includes the amplifier A11, resistor R51, and capacitor C51. The amplifier A11 produces a respective signal VCTRL_TRL at node N5 indicating or based on a difference between the local power converter phase temperature TPHASE signal (such as any of TPHASE11, TPHASE12, TPHASE21, TPHASE22, TPHASE1, TPHASE2, TPHASE3, TPHASE4) and the signal TPHMAX-TDEAD (or simply TPHMAX) depending on the instantiation of the temperature balance function. The node N51 connecting the resistor R51 and the capacitor C51 stores a respective signal VCTRL_TRL supplied to the analog-to-digital converter 561. The analog-to-digital converter 561 converts the received signal VCTRL_TRL into signals D1 and D0supplied to the multiplexer 562. The multiplexer 562 uses the received signals D1 and D0 as address lines to select which delayed version of the PWM signal to output as signal 563 to the D flip-flop 522. Subsequent circuitry such as D flip-flop 523, D flip-flop 524, logic 525, D flip-flop 528, use the signal 591 as a basis in which to control adjustment of the trailing edge of the signal PWMC (such as signal PWM1XC or PWMYC) as indicated in the prior timing diagrams.

Via the temperature balance function (i.e., circuit) shown in FIG. 6, as previously discussed, when the magnitude of the signal TPHASE (temperature of local phase) is less than the signal TPHMAX-TDEAD or TPHMAX, the trailing edge of the respective signal PWMC is delayed by varying amounts as selected by the multiplexer 562 to increase output current supplied by the local power converter phase.

For example, if a magnitude of the temperature of the local phase is greater than or equal to the value TPHMAX-TDEAD or TPHMAX, the analog-to-digital converter 561 produces selection signals in which C0=0 and C1=0 (inputs to the multiplexer 562) resulting in a minimal or no change in the duty cycle associated with the pulse width modulation signal PWMc with respect to the pulse width modulation signal PWMIN.

However, depending upon the magnitude of the temperature of the local power converter phase being less than the maximum temperature TPHMAX, the analog-to-digital converter 561 produces different settings for C1 and C0 to delay the trailing edge of the pulses modulation control signal PWMC with respect to the pulse width modulation control signal PWMIN, resulting in the pulse width modulation control signal PWMc having a greater on-time of activating high-side switching me to increase the respective amount of current supplied by that power converter phase to the load 108 team.

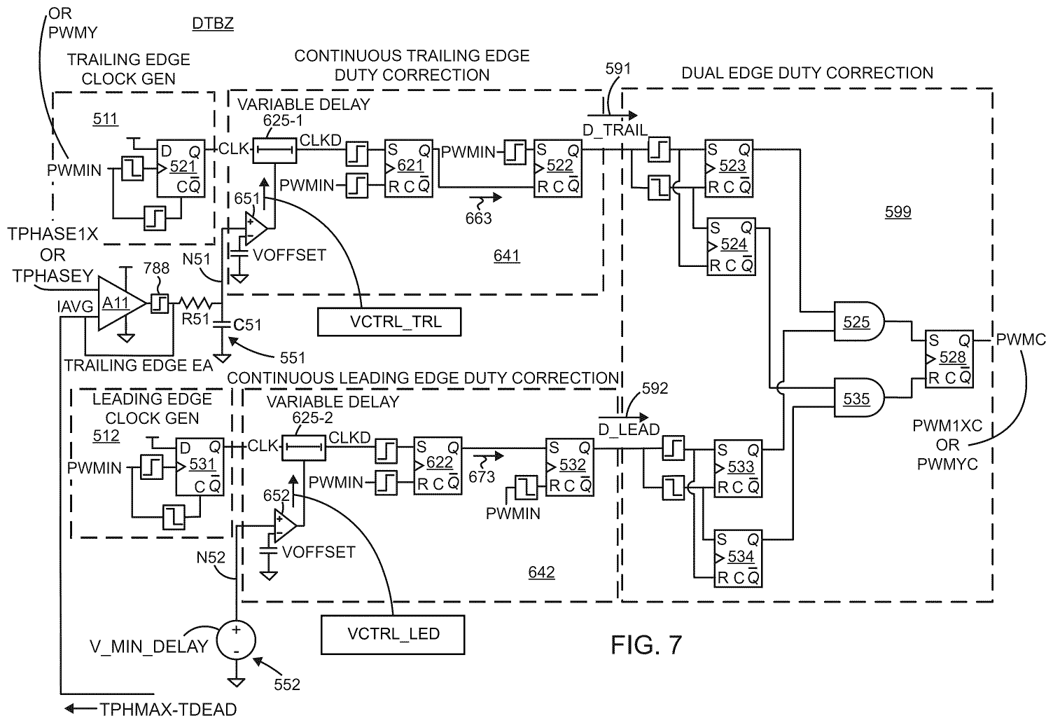

FIG. 7 is an example diagram illustrating a pulse width modulation signal generator operable to adjust leading and trailing edges of a respective received control signal as discussed herein.

The continuous trailing edge duty correction circuit 641 includes a variable delay circuit 625-1, D flip-flop 621, D flip-flop 522, and amplifier circuitry 651. The continuous leading-edge duty correction circuit 642 includes a variable delay circuit 625-2, D flip-flop 622, D flip-flop 532, and amplifier circuitry 652.

In this example, the leading-edge correction is implemented to maintain high-resolution duty cycle adjustment. Trailing edge correction allows current increase as discussed herein. The current limiter 788 prevents excessive duty cycle excursion to limit current imbalance. The voltage_vmin_delay provided by the voltage source 552 ensures minimum delay for the leading-edge generator functionality, which results in fine resolution relative pulse width modulation.

The integrator circuit 551 includes the amplifier A11, resistor R51, and capacitor C51. The amplifier A11 produces a respective output signal based on a comparison of the temperature of the respective phase (such as indicated by TPHASE1X or TPHASEY) at node N51. The node N51 connecting the resistor R51 and the capacitor C51 stores a respective signal supplied to the amplifier circuitry 651, which converts the voltage at node N51 into a respective signal VCTRL_TRL supplied to the variable delay circuit 625-1. The variable delay circuit 625-1 receives the original signal PWMIN and, as its name suggests, varies an amount of delay (392) applied to the trailing edge of the received control signal PWMIN to produce the control signal PWMc depending upon a magnitude of the signal VCTL_TRL. Details of the variable delay circuit for 625-1 are shown in FIG. 7.

Via the temperature balance function (i.e., circuit) shown in FIG. 6, as previously discussed, when the magnitude of the temperature associated with the local power converter phase is less than the hottest power converter phase within margin TDEAD, the trailing edge of the respective signal PWMC is delayed by varying amounts as selected by the variable delay circuit 625-X (625-1). For example, as the difference between the corresponding power converter phase and the hottest power converter phase increases, the magnitude of the delay (VCTRL) controlling adjustments to the trailing edge delay 392 of the final control signal PWMc also increases, resulting in the corresponding lower temperature power converter phase supplying additional current to the respective load as previously discussed.

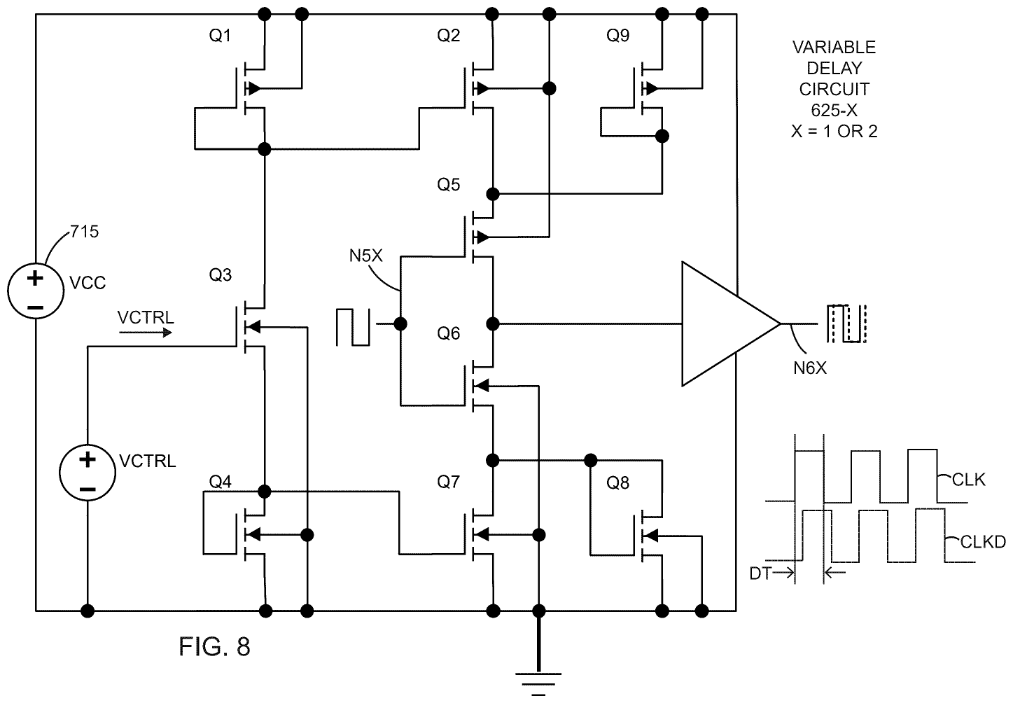

FIG. 8 is an example diagram illustrating a variable delay circuit operative to delay a clock signal as discussed herein.

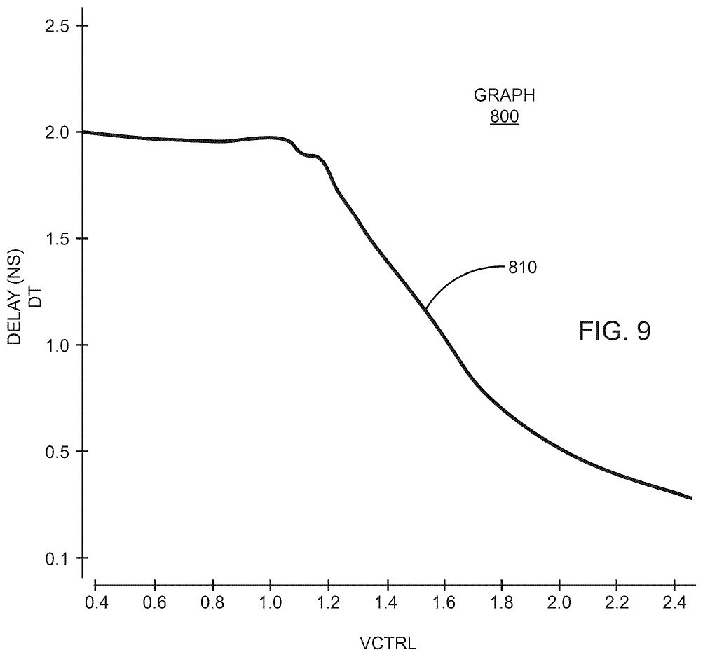

In this example, the variable delay circuit 625-X (from FIG. 7, where X=1 or X=2) includes multiple field effect transistors Q1-Q9. Power source 715 applies the input voltage Vcc to power the corresponding variable delay circuit 625-X. The variable delay circuit 625-X receives the clock signal CLK at node N5X and outputs the delayed clock signal CLKd at node N6X. Graph 800 in the following FIG. 9 illustrates the amount of delay between the clock CLK and output clock CLKd as a function of the inputted control signal VCTRL (for the leading edge VCTRL_TRL or the trailing edge VCTRL_LED).

In one example, the variable delay circuit 625-X may be a current starved inverter. In such an instance, the first power converter controller (such as current balance function DCB) associated with the power converter phase is configured to implement a first current starved inverter circuit (such as variable delay circuit 625-1) to convert the first control signal PWM IN (PWM1X) into the control signal PWM1XC, where the first current starved inverter circuit is operative to control timing of a trailing edge of the control signal PWMC on an as needed basis.

As previously discussed, the variable delay circuit 625-X may be a current starved inverter. In such an instance, the first power converter controller (such as current balance function DCB) associated with the power converter phase is configured to implement a second current starved inverter circuit (such as variable delay circuit 625-2) to convert the first control signal PWM IN (PWM1X) into the control signal PWM1XC, where the second current starved inverter circuit is operative to control timing of a leading edge of the control signal PWMC on an as needed basis.

FIG. 9 is an example diagram illustrating delay versus input voltage associated with the variable delay circuit as discussed herein.

In this example, the graph 800 includes function 810 indicating an amount of time delay (to delay the leading edge or to delay the trailing edge) provided by the variable delay circuit as previously discussed. Note that the function 810 may vary depending upon one or more parameter such as temperature, etc., associated with the corresponding variable delay circuit.

Referring again to FIG. 7, the voltage source 552 produces a respective voltage signal V_min_delay at node N52. The signal V_min_delay at node N52 is conveyed to the amplifier circuitry 652, which converts the voltage at node N52 into a respective signal VCTRL_LED supplied to the variable delay circuit 625-2 to implement a minimal delay of the leading-edge associated with the pulse width modulation control signal PWMC with respect to the pulse width modulation control signal PWMIN.

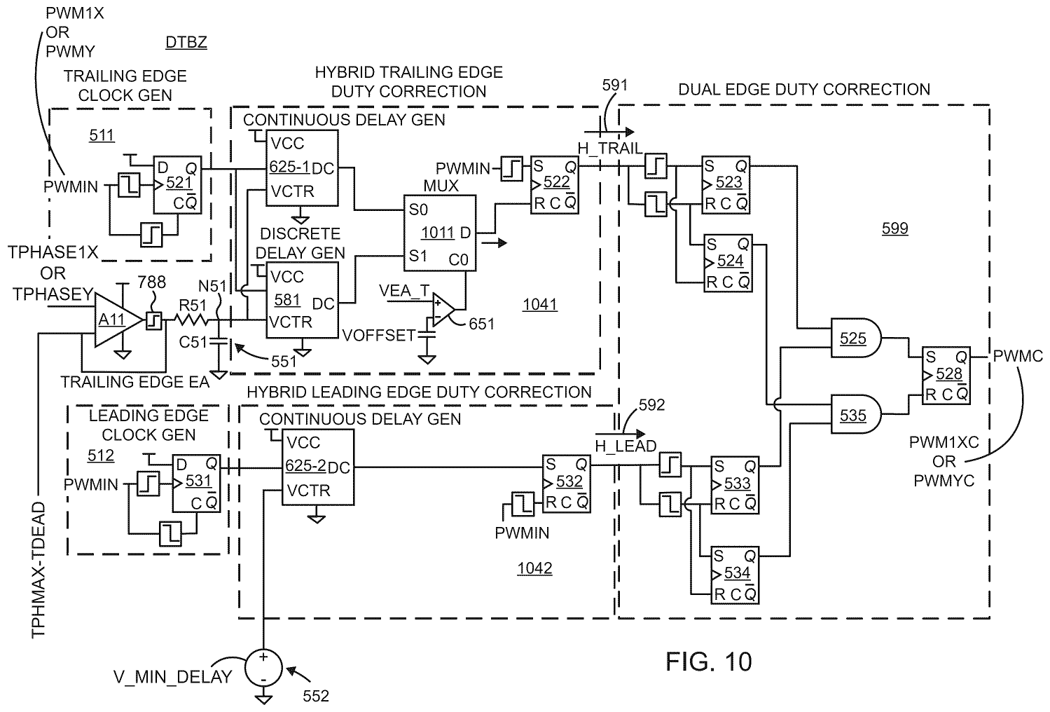

FIG. 10 is an example diagram illustrating a hybrid pulse width modulation signal generator as discussed herein.

In this example, the power converter phase DTBz includes the hybrid trailing edge duty correction circuit 1041. Additionally, the power converter phase DTBz includes the hybrid leading-edge duty correction circuit 1042.

As shown in FIG. 10, the hybrid trailing edge duty correction circuit 1041 includes variable delay circuit 625-1 as well as the discrete delay circuit 581. As previously discussed, the integrator circuit 551 produces a respective voltage at node N51 indicating a magnitude of error between the hottest power converter phase and the current power converter phase (respective cooler power converter phase). The signal at node N51 is conveyed to the VCTR input of the variable delay circuit 625-1 and the VCTR input of the circuit 581.

The variable delay circuit 625-1 and the circuit 581 receive the original signal PWMIN and, as its name suggests, vary an amount of delay applied to the trailing edge of the received control signal PWMIN to produce the control signal PWMc depending upon a magnitude of the signal VCTL_TRL. In this example, the multiplexer 1011 selects between the continuous delay generator 625-1 or the discrete delay generator 581 in which to output a respective signal to the D flip-flop 522.

If the magnitude of the power converter temperature difference as indicated by the voltage at node N51 is above a threshold, the circuit 651 causes the multiplexer to select channel S0 using the output of the variable delay circuit 625-1 to convey to D flip-flop 522, in which case the trailing edge associated with the signal PWMc is generated based on the output of the variable delay circuit 625-1.

Conversely, if the magnitude of the error is above a threshold, the circuit 651 causes the multiplexer to select channel S1 using the output of the circuit 581 conveyed to D flip-flop 522, in which case the trailing edge associated with the signal PWMc is generated based on the output of the circuit 581.

As further shown in FIG. 10, the hybrid leading edge duty correction circuit 1042 includes variable delay circuit 625-2 as well as D flip-flop 532. Voltage V_min_delay is inputted to the VCTR pin of variable delay circuit 625-2. The output of the variable delay circuit 625-2 is outputted to the D flip-flop 532 to control the signal 592 and provide a minimum delay associated with leading-edge of the signal PWMC.

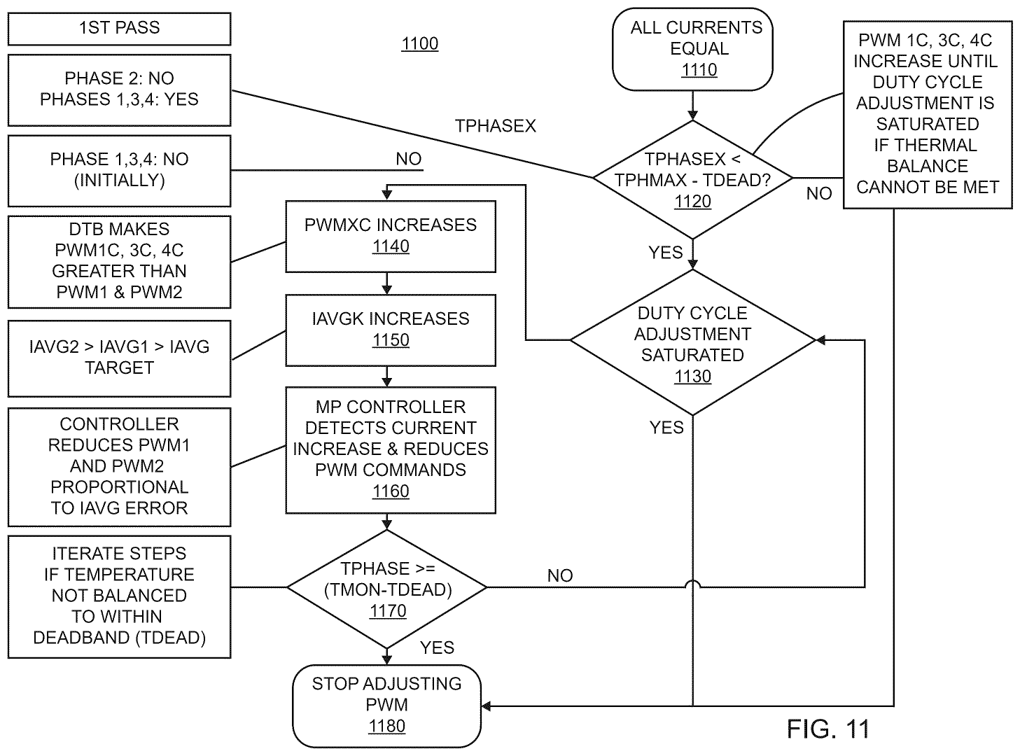

FIG. 11 is an example flow chart diagram illustrating operations of controlling output of current from each of multiple different power converters as discussed herein.

Flowchart 1100 in FIG. 11 illustrates temperature balancing as discussed herein. In initial state 1110, assume that each of the power converters in FIG. 1 or FIG. 3 supplies a substantially equal amount of current to the load 118. In other words, assume that the current i11, i12, i21, and i22 are substantially equal.

However, further assume that power converter phase 112 is the hottest power converter phase in the group. In such an instance, the power converter phase 112 transmits the corresponding signal TPHMAX out of the corresponding terminal T12 to node N99. Each of the components such as power converter phase 111, power converter phase 121, power converter phase 122, and multiphase controller 140 receives the signal TPHMAX at respective terminals T11, T21, and T22. As previously discussed, the signal TPHMAX indicates a corresponding magnitude of the temperature of the power converter phase 112.

The following operations are executed by the power converter phases to substantially equalize or better balance the temperature of each of the power converter phases.

More specifically, in processing operation 1120, each of the power converter phases having a temperature less than the temperature of the hottest power converter phase as indicated by the signal TPHMAX determines whether or not to implement current adjustments to increase its respective temperature with respect to the hottest power converter phase. For example, in processing operation 1120, each of the power converter phase 111, power converter phase 121, power converter phase 122, compares a magnitude of their respective detected temperature (TPHASEX) to the magnitude of the hottest temperature as indicated by TPHMAX. That is, in one example, each respective power converter determines whether the temperature is less than TPHMAX-TDEAD.

On the first pass, assume that each of the power converter phases 111, 121, and 122 determines (YES) that their temperature is less than TPHMAX-TDEAD. As previously discussed, the value TDEAD is a temperature margin value. Based on the determination in operation 1120, processing for each of the power converter phases 111, 121, 122 therefore continues at processing operation 1130.

Note that the power converter phase 112 (such as Phase 2) in processing operation 1120 determines that its corresponding temperature TPHMAX is not less than TPHMAX-TDEAD and therefore executes processing operation 1180 where the power converter phase 112 does not adjust its pulse width modulation signal to increase its output current. At processing operation 1130, each of the power converter phases 111, 121, 122, determines whether any duty cycle adjustments associated with the respective received pulse width modulation signals PWM1 or PWM2 has reached an adjustment saturation level. If so, for those power converter phases in saturation, processing continues at processing operation 1180. If not, processing continues at processing operation 1140 for those power converter phases.

At processing operation 1140, as previously discussed, each of the respective power converter phases 111, 121, 122, increases a respective duty cycle associated with the corresponding received signal PWM1 and PWM2 such that each of the power converter phases 111, 121, 122, now output a higher amount of current to the load 118. As indicated in processing operation 1150, the average current supplied to the load 118 increases as a result of each of the power converter phases 111, 121, 122, increasing their respective output current in processing operation 1140. In response to the increased current, in subsequent processing operation 1160, the multiphase controller 140 reduces the duty cycle (on-time of high-side switch circuitry of the power converter phases) associated with one or more of the pulse width modulation signals PWM1 and PWM2 so that the magnitude of the output voltage 123 is substantially equal to the reference VREF1. In other words, if the multiphase controller 140 does not reduce the duty cycle, the output voltage 123 will go out of regulation.

In processing operation 1170, each of the power converter phases 111, 121, and 122, further compares their respective temperature to the TPHMAX or TPHMAX-TDEAD (i.e., a threshold level) again. For example, each of the power converter phases 111, 121, 122, detects that their respective temperature is less than TPHMAX-TDEAD resulting in loopback and continued execution of the flowchart 1100 at processing operation 1130 again.

Each of the power converter phases repeats this loop of processing operations (1130, 1140, 1140, 1150, 1160, 1170) until the respective power converters detect that their temperature is equal to or greater than TPHMAX-TDEAD in which case the power converter phases X execute processing operation 1180 where no more duty cycle adjustments are made to change the current. In other words, when the current adjustment to each of the power converter phases results in the temperature of the power converter phase being within the marginal temperature limit TDEAD of the maximum temperature power converter phase (TPHMAX of the power converter phase 112) or saturation, the power converter phases 111, 121, and 122 discontinue increasing their output current to the load.

The increase in the output current of the power converter phases 111, 121, 122 reduces the current supplied by the power converter phase 112 to the load as well as a magnitude of the temperature of the power converter phase 112.

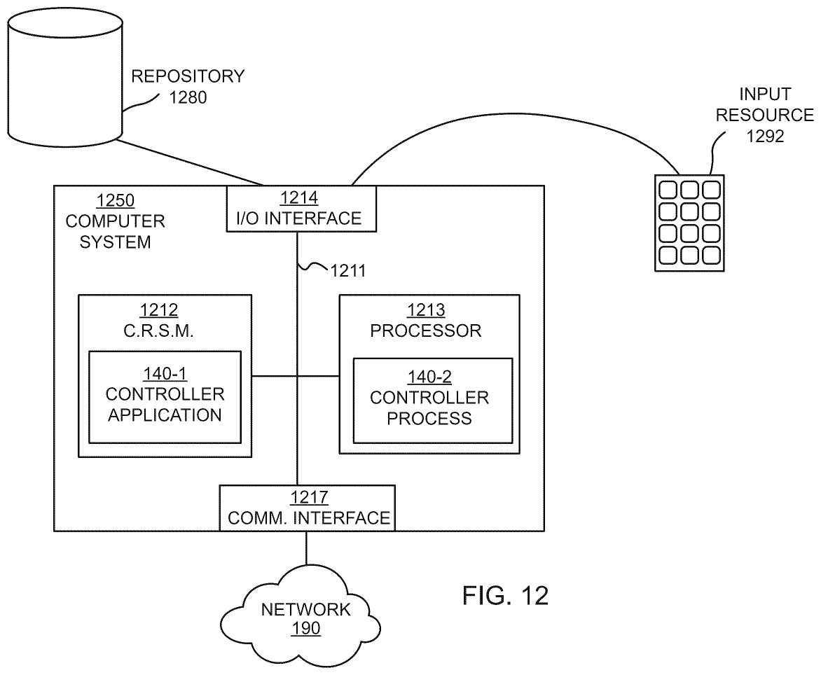

FIG. 12 is an example block diagram of a computer device for implementing any of the operations as discussed herein according to examples herein.

As shown, computer system 1250 (such as implemented by any of one or more resources such as controller 140, current balance functions DTB, etc.) of the present example includes an interconnect 1211 that couples computer readable storage media 1212 such as a non-transitory type of media (or hardware storage media) in which digital information can be stored and retrieved, a processor 1213 (e.g., computer processor hardware such as one or more processor devices), I/O interface 1214 (e.g., to output control signals to the power converter phases, monitor current, etc.), and a communications interface 1217.

I/O interface 1214 provides connectivity to any suitable circuitry such as power converter phases.

Computer readable storage medium 1212 can be any hardware storage resource or device such as memory, optical storage, hard drive, floppy disk, etc. In one example, the computer readable storage medium 1212 stores instructions and/or data used by the controller application 140-1 (such as implemented by any of controller 140, DCBs, etc., to support leading-edge and/or trailing edge signal adjustments) to perform any of the operations as described herein.

Further in this example, communications interface 1217 enables the computer system 1200 and processor 1213 to communicate over a resource such as network 190 to retrieve information from remote sources and communicate with other computers.

As shown, computer readable storage media 1212 is encoded with controller application 140-1 (e.g., software, firmware, etc.) executed by processor 1213. Controller application 140-1 can be configured to include instructions to implement any of the operations as discussed herein.

During operation of one example, processor 1213 accesses computer readable storage media 1212 via the use of interconnect 1211 in order to launch, run, execute, interpret or otherwise perform the instructions in controller application 140-1 stored on computer readable storage medium 1212.

Execution of the controller application 140-1 produces processing functionality such as controller process 140-1 in processor 1213. In other words, the controller process 140-B associated with processor 1213 represents one or more aspects of executing controller application 140-A within or upon the processor 1213 in the computer system 1200.

In accordance with different examples, note that computer system 1200 can be a micro-controller device, logic, hardware processor, hybrid analog/digital circuitry, etc., configured to control a power supply and perform any of the operations as described herein.

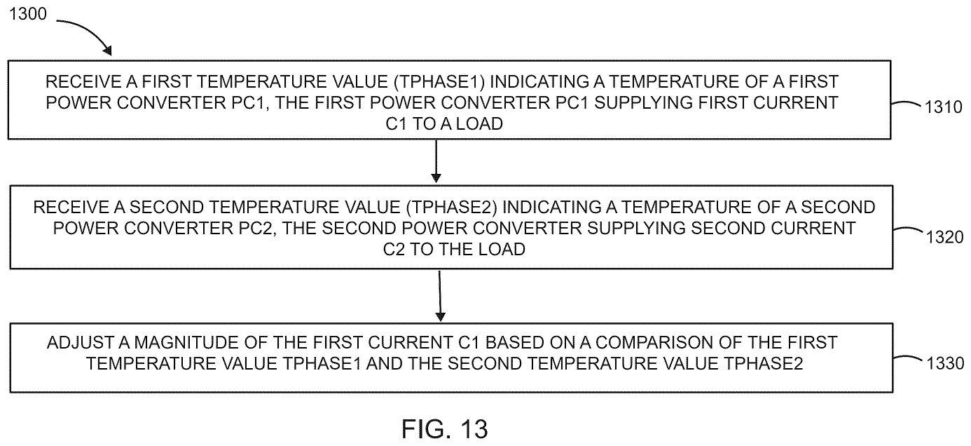

Functionality supported by the different resources will now be discussed via flowchart in FIG. 13. Note that the steps in the flowcharts below can be executed in any suitable order.

FIG. 13 is an example diagram illustrating a flowchart and implementation of a corresponding method as discussed herein.

In processing operation 1310, a first power converter receives a first temperature value indicating a temperature of the first power converter such as power converter phase 111 or power converter phase 101. The first power converter supplies first current to a load.

In processing operation 1320, the first power converter receives a second temperature value indicating a temperature (such as hottest power converter phase) of a second power converter such as power converter phase 112 or power converter phase 102. The second power converter supplies second current to the load.

In processing operation 1330, the first power converter adjusts a magnitude of the first current based on a comparison of the first temperature value and the second temperature value.

Note again that techniques herein are well suited for use in circuit applications such as those implementing power conversion and power converter temperature balancing adjustment based at least in part on temperature. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
a first power converter operative to:
receive a first temperature value indicating a temperature of the first power converter, the first power converter supplying first current to a load;
receive a second temperature value indicating a temperature of a second power converter, the second power converter supplying second current to the load; and
adjust a magnitude of the first current based on a comparison of the first temperature value and the second temperature value.

2. The apparatus as in claim 1, wherein the comparison of the first temperature value and the second temperature value indicates that the first power converter is lower in temperature than the second power converter.

3. The apparatus as in claim 2, wherein the first power converter is further operative to:
receive a first pulse width modulation control signal, the first pulse width modulation control signal supplied to both the first power converter and the second power converter to control the first current and the second current; and
in response to the first temperature value being less than the second temperature value, adjust timing of an edge of the received first pulse width modulation control signal to produce a second pulse width modulation control signal, the second pulse width modulation control signal operative to control a magnitude of the first current.

4. The apparatus as in claim 3, wherein the edge is a trailing edge of the received first pulse width modulation control signal.

5. The apparatus as in claim 3, wherein a duty cycle of the first pulse width modulation signal received by the first power converter is adjusted by a controller in response to the first power converter adjusting a magnitude of the first current.

6. The apparatus as in claim 1, wherein the first power converter is operative to discontinue increasing the magnitude of the first current in response to detecting that the first temperature value is within a threshold level of the second temperature value.

7. The apparatus as in claim 1, wherein the first power converter is operative to adjust a magnitude of the first current via selection of a delay signal from a tapped delay line to control a respective timing of an edge of a first control signal controlling the magnitude of the first current.

8. The apparatus as in claim 1, wherein the first power converter is operative to adjust the magnitude of the first current via implementation of a first current starved inverter circuit, the current starved inverter circuit operative to adjust timing of a trailing edge of a first control signal to produce a second control signal, the second control signal operative to control the magnitude of the first current.

9. The apparatus as in claim 1, wherein the first power converter is operative to: i) receive a first control signal to control a magnitude of the first current, and ii) via a continuous delay element circuit, convert the first control signal into a second control signal, the current continuous delay element circuit operative to control timing of a trailing edge of the second control signal.

10. An apparatus comprising:
a first power converter operative to:
receive a control signal supplied to each of multiple power converters including the first power converter and a second power converter;
receive temperature information associated with the first power converter and the second power converter; and
adjust the control signal based on the received temperature information, the adjusted control signal operative to control first current outputted from the first power converter to a load.

11. The apparatus as in claim 10, wherein the temperature information includes a first temperature value and a second temperature value;
wherein the first temperature value indicates a temperature of the first power converter; and
wherein the second temperature value indicates a temperature of the second power converter.

12. The apparatus as in claim 11, wherein the control signal is a pulse width modulation control signal supplied to both the first power converter and the second power converter.

13. The apparatus as in claim 12, where adjustment of the control signal based on the temperature information includes:
adjusting a duty cycle of the pulse width modulation control signal implemented by the first power converter to produce the first current in response to a condition in which the second temperature value is greater than the first temperature value.

14. The apparatus as in claim 13, wherein the adjusted duty cycle of the pulse width modulation control signal implemented by the first power converter is operative to reduce: i) a magnitude of second current supplied by the second power converter to the load, and ii) a magnitude of the temperature of the second power converter.

15. A method comprising:
receiving a first temperature value indicating a temperature of a first power converter, the first power converter supplying first current to a load;
receiving a second temperature value indicating a temperature of a second power converter, the second power converter supplying second current to the load; and
adjusting a magnitude of the first current based on a comparison of the first temperature value and the second temperature value.

16. The method as in claim 1, wherein the comparison of the first temperature value and the second temperature value indicates that the first power converter is lower in temperature than the second power converter.

17. The method as in claim 16, wherein adjusting the magnitude of the first current includes increasing the magnitude of the first current in response to detecting that the first temperature value is less than the second temperature value based on the comparison.

18. The method as in claim 17, wherein the increased magnitude of the first current decreases a magnitude of the second current supplied by the second power converter to the load;
wherein the increased magnitude of first current increases in the temperature of the first power converter; and
wherein the decreased magnitude of the second current supplied by the second power converter to the load reduces the temperature of the second power converter.

19. The method as in claim 15, wherein the adjusted magnitude of the first current increases a difference between a magnitude of the first current and the magnitude of the second current; and
wherein adjusting the magnitude of the first current based on the comparison includes preventing the difference between the magnitude of the first current and the magnitude of the second current from being greater than a threshold level.

20. The method as in claim 15, wherein adjusting the magnitude the first current based on the comparison includes:
receiving a first pulse width modulation control signal, the first pulse width modulation control signal supplied to both the first power converter and the second power converter to control the first current and the second current; and
in response to the first temperature value being less than the second temperature value, adjust timing of an edge of the received first pulse width modulation control signal to produce a second pulse width modulation control signal, the second pulse width modulation control signal operative to control a magnitude of the first current.
